(19) United States
(12) Patent Application Publication
(10) Pub. No.: US 2010/0304202 A1
(43) Pub. Date: Dec. 2, 2010

(54) RECHARGEABLE BATTERY

(75) Inventors: CHIA-SHIN CHOU, Tu-Cheng (TW); MING-KE CHEN, Shenzhen City (CN); ZHEN-XING YE, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., SHENZHEN CITY (TW); HON HAI PRECISION INDUSTRY CO., LTD., TU-CHENG (TW)

(21) Appl. No.: 12/617,632

(22) Filed: Nov. 12, 2009

(30) Foreign Application Priority Data
Jun. 2, 2009 (CN) 200910302841.7

(51) Int. Cl. H01M 10/50

(52) U.S. Cl. 429/120

(57) ABSTRACT

A rechargeable battery includes a receiving member, a circuit board, a number of batteries, and a heat dissipating member. The circuit board, the number of batteries, and the heat dissipating member are mounted to the receiving member. A connector is mounted to the receiving member, and extends outward from the receiving member. The connector and the number of batteries are electrically connected to the circuit board. The heat dissipating member is covered on, and in contact with, the plurality of batteries, the heat dissipating member is made of material of high heat conductivity.

### BACKGROUND

1. Technical Field

The disclosure relates to a rechargeable battery used in an electronic device.

2. Description of Related Art

A conventional electronic device, such as a notebook computer, may include a rechargeable battery used as a power supply. Therefore, it is convenient to use the notebook computer outdoors. However, using the rechargeable battery may produce too much heat, which can affect functioning of or even cause damage to the electronic device.

### BRIEF DESCRIPTION OF THE DRAWINGS

FIG. 1 is an exploded, isometric view of an exemplary embodiment of a rechargeable battery, the rechargeable battery including a battery cover.

FIG. 2 is an inverted view of FIG. 1.

FIG. 3 is a partially assembled, isometric view of the rechargeable battery of FIG. 1, without showing the battery cover.

FIG. 4 is an assembled, isometric view of the rechargeable battery of FIG. 1.

### DETAILED DESCRIPTION

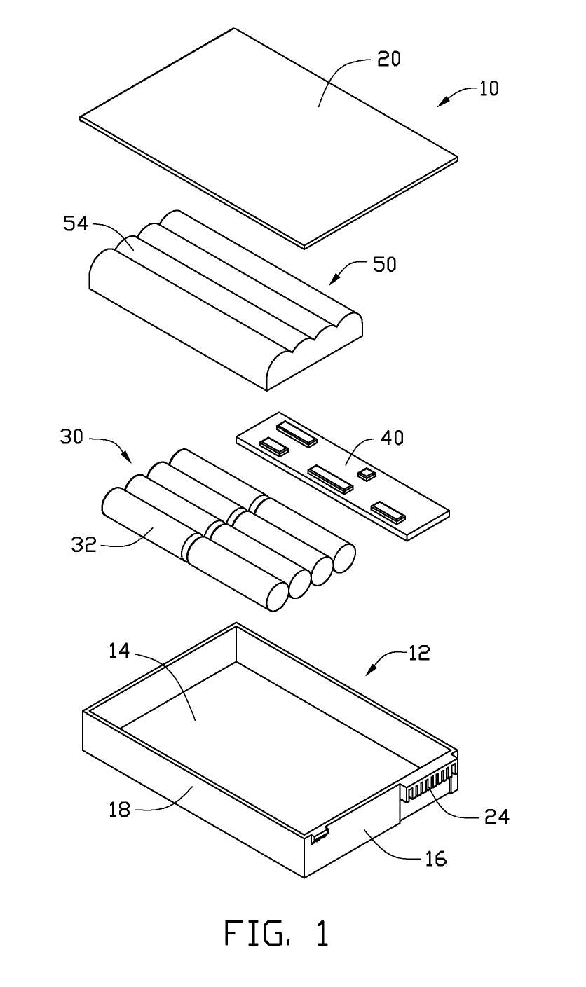

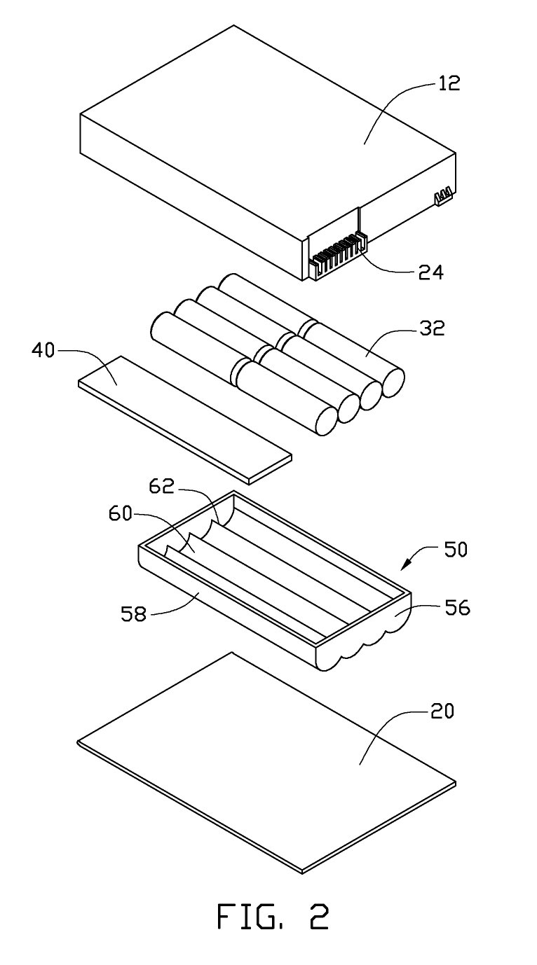

Referring to FIGS. 1 and 2, an exemplary embodiment of a rechargeable battery is used in an electronic device such as a notebook computer. The rechargeable battery includes a receiving member 10, a battery collection 30 mounted in the receiving member 10, a circuit board 40, and a heat dissipating member 50.

The receiving member 10 includes a receiving box 12 and a battery cover 20 for the receiving box 12. The receiving box 12 includes a bottom panel 14, two first sidewalls 16 perpendicularly extending from opposite ends of the bottom panel 14, and two second sidewalls 18 perpendicularly extending from opposite sides of the bottom panel 14. The second sidewalls 18 are perpendicularly connected to the corresponding first sidewalls 16. A connector 24 is mounted to one of the first sidewalls 16, opposite to the other one of the first sidewalls 16, for electrically connecting to a power supply (not shown).

The battery collection 30 includes a plurality of series-wound batteries 32.

The heat dissipating member 50 is made from metal, alloy, or other material with high heat conductivity, for dissipating heat generated by the battery collection 30. The heat dissipating member 50 includes a wave-shape bottom slab 54, two first side plates 56 perpendicularly extending from opposite ends of the bottom slab 54, and two second side plates 58 perpendicularly extending from opposite sides of the bottom slab 54. The second side plates 58 are perpendicularly connected to the first side plates 56. A plurality of separate clapboards 62 extend from the bottom slab 54, and opposite ends of each of the clapboards 62 are connected to the corresponding first side plates 56. Therefore, a receiving slot 60 is defined by every two adjacent clapboards 62 and the first side plates 56, for receiving a corresponding one of the plurality of batteries 32 of the battery collection 30.

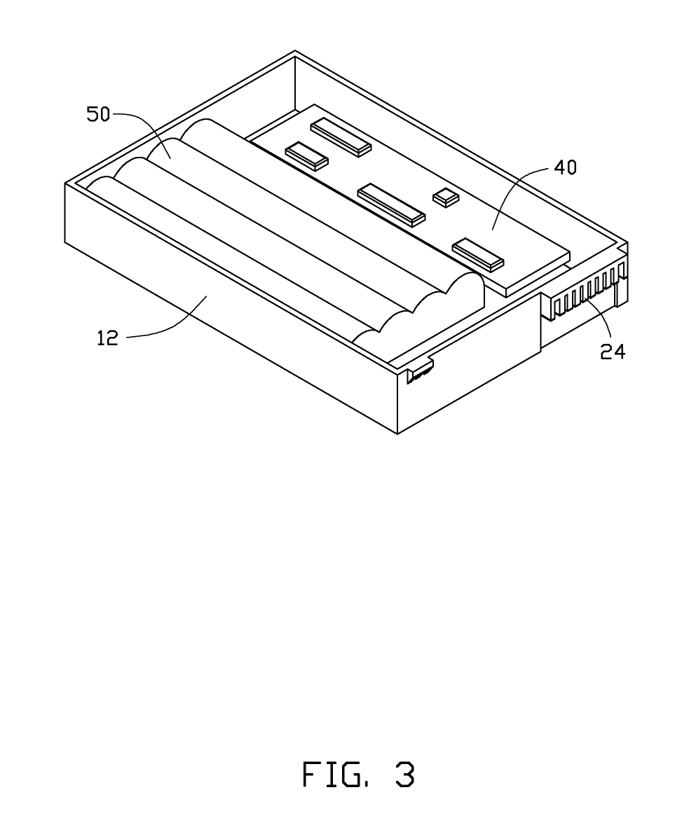

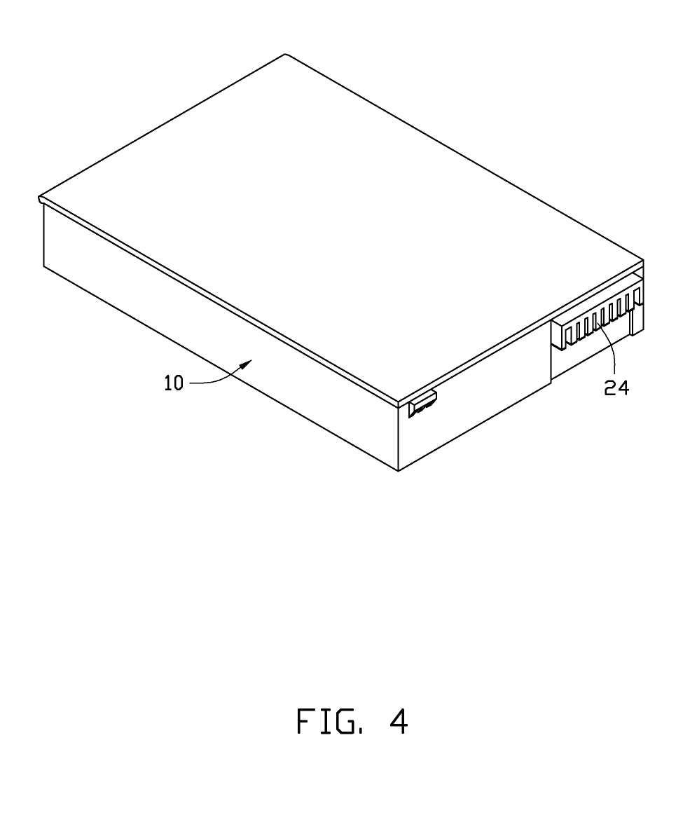

Referring to FIGS. 3, and 4, in assembly, the plurality of batteries 32 of the battery collection 30 and the circuit board 40 are mounted to the bottom panel 14 of the receiving member 10, and situated side by side. The plurality of batteries 32 and the connector 24 are electrically connected to the circuit board 40, and then, the heat dissipating member 50 is mounted to the bottom panel 14, and covered on the plurality of batteries 32. The batteries 32 are received in the corresponding receiving slots 60 of the heat dissipating member 50, and contacted to the corresponding clapboards 62, thereby, heat generated by the batteries 32 is dissipated via the heat dissipating member 50. The battery cover 20 of the receiving member 10 is covered on the receiving box 12.

In addition, if the batteries 32 should still become overheated and explode, the heat dissipating member 50 covered on the plurality of batteries 32 can help reduce damage caused by the explosion.

It is believed that the present embodiments and their advantages will be understood from the foregoing description, and it will be apparent that various changes may be made thereto without departing from the spirit and scope of the description or sacrificing all of its material advantages, the examples hereinbefore described merely being exemplary embodiments.

What is claimed is:

1. A rechargeable battery comprising:
a receiving member;
a connector mounted to and extending out of the receiving member;
a circuit board mounted to the receiving member;
a plurality of batteries mounted to the receiving member; wherein the connector and the plurality of batteries are electrically connected to the circuit board; and
a heat dissipating member mounted to the receiving member, wherein the heat dissipating member is covered on, and in contact with, the plurality of batteries, the heat dissipating member is made of material of high heat conductivity.

2. The rechargeable battery of claim 1, wherein the heat dissipating defines a plurality of receiving slots, the plurality of batteries are received in the plurality of receiving slots, respectively.

3. The rechargeable battery of claim 2, wherein the heat dissipating member comprises a bottom slab, and a plurality of clapboards extend from the bottom slab, each receiving slot is formed between the adjacent clapboards, and the plurality of batteries are contacted with the corresponding clapboards.

4. The rechargeable battery of claim 3, wherein the bottom slab is generally wave-shaped, the heat dissipating member further comprises two first side plates extending from opposite ends of the bottom slab, opposite ends of each of the plurality of clapboards are connected to the first side plates.

5. The rechargeable battery of claim 4, wherein the heat dissipating member further comprises two second side plates extending from opposite sides of the bottom slab, the second side plates are parallel to the clapboards and perpendicularly connected to the first side plates.

6. The rechargeable battery of claim 2, wherein the receiving member comprises a receiving box having a bottom panel, the plurality of batteries and the heat dissipating member are mounted to the bottom panel, and the plurality of receiving slots face the bottom panel.

7. The rechargeable battery of claim 1, wherein the receiving member comprises a receiving box comprising a bottom panel, the plurality of batteries and the circuit board are mounted to the bottom panel, and situated side by side.

8. The rechargeable battery of claim 7, wherein the heat dissipating member is mounted to the bottom panel, the heat dissipating member defines a plurality of receiving slots facing the bottom panel, the plurality of batteries are received in the corresponding receiving slots.

9. The rechargeable battery of claim 7, wherein the receiving box further comprises two first sidewalls extending from opposite ends of the bottom panel, and two second sidewalls extending from opposite sides of the bottom panel, the second sidewalls are perpendicularly connected to the first sidewalls.

10. The rechargeable battery of claim 9, wherein the connector is mounted to one of the first sidewalls.

11. The rechargeable battery of claim 7, wherein the receiving member further comprises a battery cover, the battery cover is covered on the receiving box.
